(19) United States
(12) Patent Application Publication
(10) Pub. No.: US 2014/0309905 A1
(43) Pub. Date: Oct. 16, 2014

(54) SYSTEM AND METHOD FOR SENDING AND RECEIVING MESSAGES BETWEEN AN ELECTRONIC CONTROL UNIT OF A VEHICLE AND AN EXTERNAL DEVICE

(71) Applicants: Michael Drew, Dexter, MI (US); Brian Herron, Dexter, MI (US); Eric Wheeler, Chelsea, MI (US); Gus Nassar, Canton, MI (US)

(72) Inventors: Michael Drew, Dexter, MI (US); Brian Herron, Dexter, MI (US); Eric Wheeler, Chelsea, MI (US); Gus Nassar, Canton, MI (US)

(21) Appl. No.: 14/246,287

(22) Filed: Apr. 7, 2014

Related U.S. Application Data
(60) Provisional application No. 61/808,860, filed on Apr. 5, 2013.

(51) Int. Cl. F02D 29/02

(52) U.S. Cl. CPC F02D 29/02
USPC 701/101

(57) ABSTRACT

The system for sending and receiving messages from an electronic control unit of the vehicle includes a processor, a database, and a port in communication with the processor. The database contains information as to the emissions of the vehicle and the port is configured to communicate with the electronic control unit of the vehicle. The processor is configured to receive information from the electronic control unit of the vehicle, compare the information from the electronic control unit of the vehicle with information found in the database. By so doing, the processor can determine if the information from the electronic control unit of the vehicle does not match the information in the database. If this is the case, the system can provide an indication to the user of the system that the vehicle may have been tampered with and any emissions related testing may be incorrect.

### CROSS REFERENCE TO RELATED APPLICATION

This application claims the benefit of U.S. provisional application No. 61/808,860 filed on Apr. 5, 2013 which is herein incorporated by reference in its entirety.

### BACKGROUND

1. Field of the Invention

The invention relates to systems and methods for sending and receiving messages from an electronic control unit of a vehicle to determine if the electronic control unit has been tampered with or is a simulator.

2. Description of Related Art

Numerous government agencies perform periodic testing for the emissions outputted by vehicles. These emission testing devices may be standalone devices that only perform emissions testing or may be general purpose computers that are loaded with the appropriate software to perform emissions testing. Testing for emissions is generally performed by connecting the emissions testing device to a port that is in communication with the electrical systems of the vehicle. The communication port is normally located between the dashboard and the brake pedal.

The port is most likely to be a Society of Automotive Engineers (“SAE”) J1962 port, better known as an On-Board Diagnostics II (“OBD-II”) port. This port allows communication between external devices and the electronic systems in communication with the bus. The bus may be connected to numerous electronic control units located within the vehicle as well as sensor systems that are also located within the vehicle.

These sensor systems routinely collect data relating to the operating of the vehicle, including emissions related data. The emissions testing device connected to the port will communicate with the electronic control units of the vehicle regarding emissions related information of the vehicle. The emissions testing device will analyze this data and make a determination if the vehicle has met the agency's standards for emission related operation.

Many automotive enthusiasts commonly perform modifications to their vehicle that may confuse the emissions testing device. This confusion of the emissions testing device can lead to the emissions testing device to make the determination that the vehicle has not passed emissions. Further, some vehicles, because poor maintenance and/or regular wear and tear, may fail emissions testing. Owners of vehicles that have either been modified or fail emissions may be tempted to try to trick the emissions testing device into determining that the vehicle has passed emissions. There are numerous procedures that can be utilized by operators seeking to trick an emissions testing device into indicating that their vehicle has passed emissions.

### SUMMARY

As its primary components, the system for sending and receiving messages from an electronic control unit of the vehicle includes a processor, a database, and a port in communication with the processor. The database contains information as to the emissions of the vehicle and the port is configured to communicate with the electronic control unit of the vehicle. The port may be an OBD-II port.

The processor is configured to receive information from the electronic control unit of the vehicle, compare the information from the electronic control unit of the vehicle with information found in the database. By so doing, the processor can determine if the information from the electronic control unit of the vehicle does not match the information in the database. If this is the case, the system can provide an indication to the user of the system that the vehicle may have been tampered with and any emissions related testing may be incorrect.

The system may also have a second port that can be connected to an external device. The external device can be configured to receive updated information regarding the emissions of the vehicle and store the updated information in the database.

In determining if the information from the electronic control unit of the vehicle does not match information in the database, a number of different methodologies can be utilized to make this determination. For examples, such methodologies could include measuring response times, comparing electronic control images and/or looking at flash counters. In addition to these, other methodologies can be performed as described in the subsections that follow.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a block diagram of a data bus found in a vehicle;

FIG. 2 illustrates a block diagram of a vehicle with the data bus of FIG. 1 connected to an emissions testing device;

FIG. 3 illustrates the vehicle of FIG. 2 connected to the system for sending and receiving messages from an electronic control unit of the vehicle;

FIG. 4 illustrates a timing diagram of communication between an emissions tester and an electronic control unit of the vehicle; and

FIG. 5 illustrates another example of a timing diagram of communication between the emissions tester and an electronic control unit of the vehicle.

### DETAILED DESCRIPTION

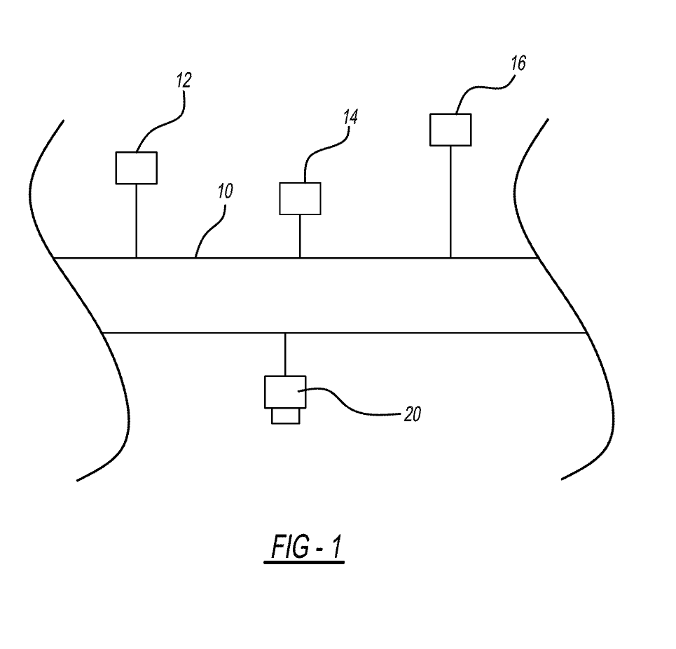

Referring to FIG. 1, a bus 10 commonly found within a vehicle is shown. The bus 10 essentially acts as a conduit for communication between various electrical systems of a vehicle. The bus may be any one of a number of different types of buses, but is generally a Controller Area Network (“CAN”) type bus.

The bus 10 may have one of a number of different electrical systems in electrical communication with the bus 10. For example, the bus 10 may be in communication with an electronic control unit 12 relating to emissions of the vehicle. The bus 10 may also be in communication with other electrical systems such as an engine control system 14 or navigation system 16. Of course, any one of a number of different electrical systems commonly found in vehicles may be in communication with the bus 10. These electrical systems may also include transmission related electrical systems, body or chassis related electrical systems, or safety related electrical systems.

Also in communication with the bus 10 is a port 20. The port 20 may be any one of a number of different ports allowing external devices to connect to the bus 10. The port 20 may be an SAEJ1962 type port commonly called an OBD-II type port. Of course, it should be understood that any one of a number of different ports could be utilized, such as USB or other serial parallel ports. In addition, it should be understood that the port 20 may also be a network access device allowing the port 20 to connect to a number of different networking protocols. Further, the port 20 could also be a wireless network access device allowing devices to wirelessly connect to the bus 10 via the network access device 20.

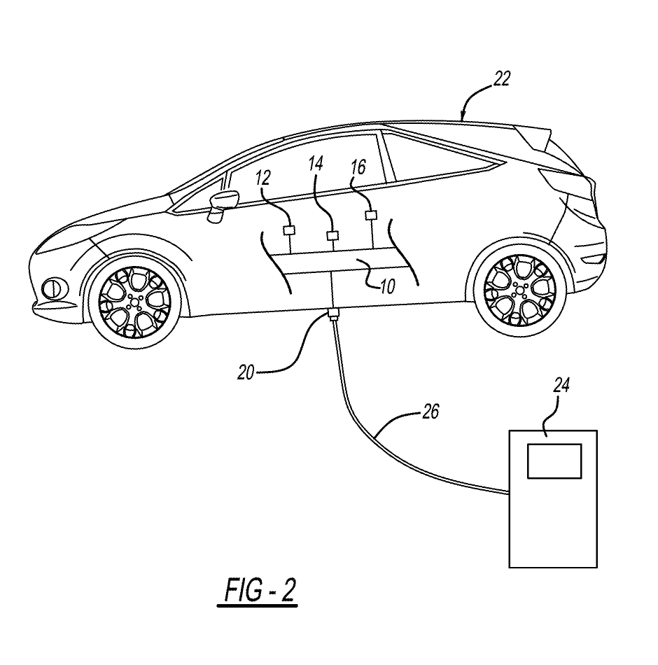

Referring to FIG. 2, a vehicle 22 is shown. The vehicle 22 incorporates the bus 10 of FIG. 1 and the associated electrical systems relating to emissions 12, engine control 14 and navigation 16. Also shown is the port 20 that is in electrical communication of the bus 10 of the vehicle 22. The vehicle 22 may be any one of a number of different vehicles. For example, the vehicle 22 may be a traditional automobile, light truck, or sport utility vehicle. In addition, it should be understood that the vehicle may be a heavy duty truck, tractor trailer or farm tractor. The vehicle 22 should not just be limited to wheeled vehicles, but could also include airplanes and boats. In any case, the vehicle 22 could be any vehicle that is capable of transporting individuals or objects from one point to another.

The port 20 is connected to an emissions testing device 24. The emissions testing device may be a dedicated device that is solely directed to testing vehicle emissions or may be a general purpose computer that has been loaded with the appropriate software to perform emissions testing. The emissions tester 24 is connected to the port 20 via a cable 26. Of course, as stated earlier, the emissions tester 24 could also be connected to the port 20 in the case where the port 20 is a network access device via a variety of different networking protocols, including wireless protocols. When connected thusly, the emissions testing device 24 can access a variety of different electronic control units connected to the bus 10 of the vehicle 22. In this case, the emissions testing device 24 would read data from emissions related electronic control unit 12.

The emissions related electronic control unit 12 essentially collects data from a variety of different sensor located within the vehicle 22 and records this information. Based on this recorded information, the emissions tester 24 or the electronic control unit 12 may make a determination that the vehicle is failing emissions or has some issue that is emissions related. Based on the data received by the emissions tester 24, the emissions tester 24 will make a determination that the vehicle has passed emissions. However, as explained in the background section, operators of vehicles that are known or likely to fail emissions testing, may be tempted to either modify the electronic control units found within the vehicle 22 or place a device located between the bus 10 and the emissions tester 24 that provides the emissions tester 24 with false data. This false data can be utilized to fool the emissions testing device 24 in to believing that the vehicle 22 has passed emissions, when it has not.

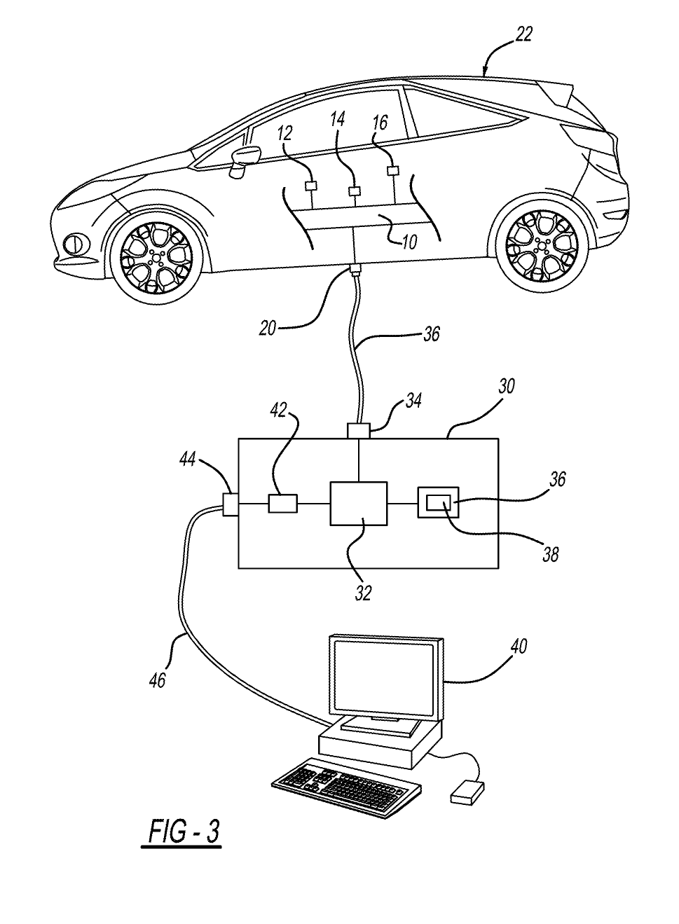

Referring to FIG. 3, the vehicle 22 of FIG. 2 is shown. In addition, a system 30 for sending and receiving messages with the electronic control unit 12 of the vehicle 22 is shown. As will be explained in greater detail in the paragraphs that follow, the system 30 is configured to determine if the electronic control unit 12 or any other device in communication with the bus 10 is providing false information relating to emissions. The device 30 could also be configured to perform emissions related testing as well in addition to its primary capabilities regarding detecting if there have been any tampering of emissions related data in the vehicle 22. The system 30 may be a dedicated device or may be a general purpose computer loaded with the appropriate software to perform an analysis of any information when the vehicle 22 has been tampered with related to emissions.

Here, the device 30 has a processor 32. The processor 32 may be a single processor or may be numerous processor spread across the system 30. In communication with the processor 32 is a port 34. The port 34 is configured to communicate with the port 20 of the vehicle 22. Generally, this is done through the use of a cable 36 to connect the port 34 to the port 20. The port 34 may be any one of a number of different ports, but generally is an OBD-II port. The port could also be any one of a number of different ports such as a USB port or other serial or parallel ports. Also, it should be understood that the port 34 could also be a network access device to communicate with the bus 10 of the vehicle 22 via a wireless connection.

The processor 32 is also in communication with the memory 36. The memory 36 may be any one of a number of different memories capable of storing digital information. For example, the memory 36 may be in optical or magnetic device, or could also be a solid state device. Additionally, the memory 36 could be incorporated within the processor 32. Stored on the memory 36 is a database 38. The database contains information relating to the diagnostic modes of the vehicle.

The device 30 may capture a vehicle fingerprint for every vehicle tested including a complete data list and list of all supported diagnostic modes. This list should be collected and processed by vehicle make/model/year/engine type and stored in the database 38. When a vehicle comes in for testing that has been tampered with, the processor 32 of the device 30 can compare that fingerprint to a database of fingerprints for vehicle make/model/year/engine type. If the tampered vehicle has a significantly different fingerprint of data from the electronic control unit 12, the vehicle should be failed due to tampering.

The processor 32 is configured to receive diagnostic information from the electronic control unit 12 of the vehicle 22, compare the diagnostic information from the electronic control unit 12 of the vehicle 22 with the information relating to the diagnostic modes of the vehicle 22 found in the database 38. The processor 32 then determines if the diagnostic information from the electronic control unit 12 of the vehicle 22 does not match the information relating to the diagnostic modes of the vehicle.

In this situation, if a determination is made that it is not a match for the information relating to the diagnostic modes of the vehicle, the operator of the device 30 would be provided some indication of failure. This could be done through a number of different ways such as a display or through appropriate lights. It should be understood that while the device 30 is receiving information from the electronic control unit 12 of the vehicle 22, in the situation where the operator vehicle 22 attempts to try to circumvent information relating to emissions of the vehicle 22, the processor 32 of the device 30 may actually be in communication with a rogue electronic control unit placed between the bus 10 of the vehicle and the connector 20.

In alternatively or additionally to those listed above, a number of different methodologies can be utilized for determining if the vehicle 22 has been tampered with can be utilized. For example, the device 30 may be configured to request from the electronic control unit 12 of the vehicle 22 and measure a response time for the data from the electronic control unit 12 of the vehicle 22. The processor 32 compares the measure response time to an expected response time and determines if the measured response time does not match the expected response time. If these do no substantially match, this is an indication that the emissions system of the vehicle 22 has been tampered with.

The processor 32 could also be configured to download a stock electronic controller image from the vehicle 22 and then compare the stock electronic control image with an original equipment manufacturer electronic control image. This original equipment manufacturer electronic control image could be stored in the database 38 on the memory 36. Based on this comparison, the processor 32 could determine if these units match and if there is no match, the determination could be made that the vehicle 22 has been tampered with. The stock electronic control unit image may have one of a monitor code, a check engine light disable code or a trouble code that are checked by the processor 32. Further, the stock electronic control unit image may also others codes that are checked by the processor 32, such as an oxygen sensor disable code, a catalytic converter disable code, a catalytic converter protection codes, a startup delay code, or a diesel particulate filter code, if the engine of the vehicle 22 is a diesel engine.

The processor 32 could also be configured to download a flash counter from the electronic control unit 12 of the vehicle 22. The flash counter essentially indicates how many times the electronic control unit 12 of the vehicle 22 has been reprogramed. Generally, the more times an electronic control unit 12 has been reprogramed, thus increasing its flash counter, the more likely that the electronic control unit 12 of the vehicle 22 has been tampered with. The flash counter can be compared by the processor 32 to a predetermined value such as 20. If the flash counter exceeds the predetermined value, the device 30 can inform the operator that the electronic control unit 12 may have been tampered with.

Additionally, the predetermined value may be provided by the manufacturer of the vehicle 22. Here, the manufacturer may have knowledge as to the amount of times the electronic control unit 12 of the vehicle 22 has been re-flashed. If the flash counter from the vehicle 22 exceeds this manufacturer provided predetermined value, the device 30 may tell the operator that the electronic control unit 12 has been tampered with.

The processor 32 of the device 30 may also download an air intake temperature from the vehicle 22. The device 30 could then receive from an input device a user provided temperature. The processor 32 would then determine if the air intake temperature downloaded from the electronic control unit matches the user provided temperature. In this situation, if there is a mismatch, this would be another indication that the electronic control unit 12 of the automobile 22 has been tampered with.

The processor 32 may also be configured to transmit an invalid message to the electronic control unit 12 of the vehicle 22 and then receive a response to the invalid message from the electronic control unit 12 of the vehicle. Based on the type of response received, the response may indicate that the response was provided by a vehicle simulator and not a legitimate electronic control unit from the vehicle 22.

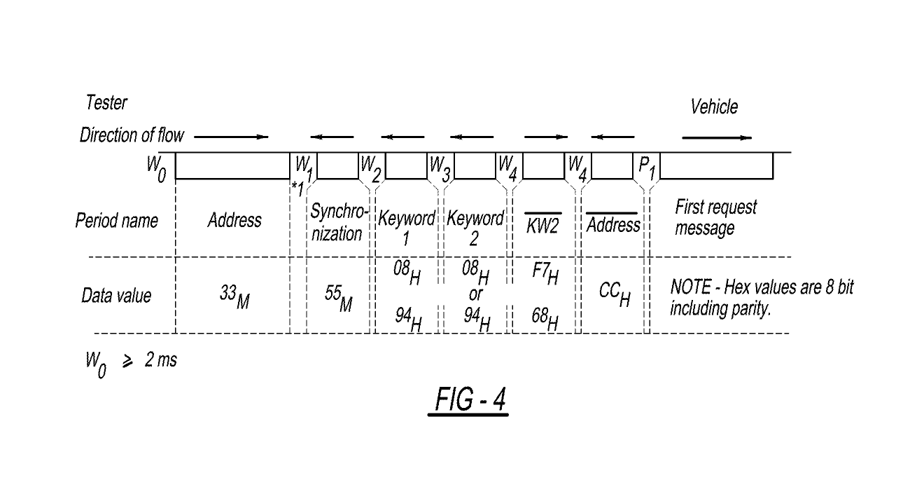

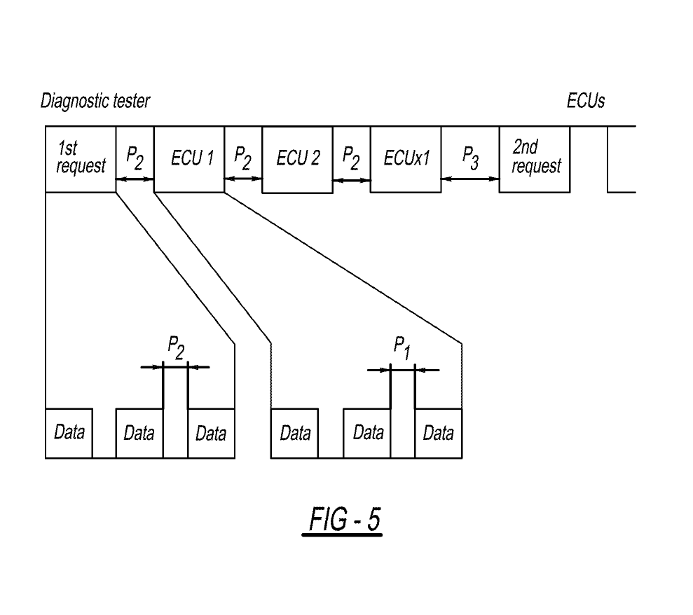

The processor 32 could also be configured to analyze the initialization of the electronic control unit 12 of the vehicle 22 to determine if the electronic control unit has been tampered with or is it a vehicle simulator. For example, in FIG. 4, careful timing analysis of initialization would enable detection of simulators or tampering of the electronic control unit 12. In FIG. 4, taking note of the timing of W1, W2, W3 and W4 would create a fingerprint for the vehicle 22. Also, in FIG. 5, taking note of P2, and P1 and recording it for each electronic control unit of a vehicle 22 that responds would provide a detailed fingerprint. For systems with multiple electronic control units, taking note of the order in which electronic control unit respond would also provide a fingerprint for the vehicle 22.

Referring back to FIG. 3, for vehicles that utilize J1850VPW, J1850PWM and CAN/ISO15765, the processor 32 could also be configured to analyze background traffic on the vehicle bus 10 to determine if the electronic control unit 12 of the vehicle has been tampered with or is it a vehicle simulator. Essentially, a number of messages should be transmitted on the vehicle bus 10, if these messages are not being transmitted, than there is a good indication that the electronic control unit 12 has been tampered with or is a vehicle simulator.

The processor 32 could also be configured to transmit a burst of requests to the electronic control unit 12 of the vehicle 22. The processor 32 then would receive responses to the burst of requests from the electronic control unit 12 and then measure the response time to the bust of request originally sent by the processor 32. Based on the response times, a determination could be made if the electronic control unit 12 of the vehicle 22 is responding at an expected response time or is responding in a delayed response time. If a delayed response time is detected, this is also an indication that the electronic control unit 12 of the vehicle has been tampered with or is a vehicle simulator.

The device 30 could also be connected to an external device 40. Essentially, the device 30 could also include a network access device 42 that is connected to a port 44. The port 44 is in turn connected to the external device 40 via a cable 46. Of course, as stated with regard to ports 20 and 34, the network access device 42 could be a wireless access device and the port 44 could be an antenna. By so doing, the external device 40 could be in wireless communication with the device 30 via the network access device 42. By so doing, the device 40 could provide updated information to be stored in the database 38 of the memory 36. For example, this updated information could include predetermined values for flash counters, a user provided air intake temperature, expected response times or electronic control unit images.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A system for sending and receiving messages from an electronic control unit of a vehicle, the system comprising:
a processor;
a database in communication with the processor, wherein the database contains information relating to the emissions of the vehicle;
a first port in communication with the processor, wherein the first port is configured to communicate with the electronic control unit of the vehicle;
wherein the processor is configured to receive emissions information from the electronic control unit of the vehicle, compare the emissions information from the electronic control unit of the vehicle with the information in the database, and determine if the emissions information from the electronic control unit of the vehicle does not match the information in the database.

2. The system of claim 1, wherein the first port utilizes an OBD-II protocol interface.

3. The system of claim 1, further comprising a memory in communication with the processor, wherein the memory contains the database.

4. The system of claim 1, further comprising:
a second port in communication with the processor, wherein the second port is configured to communicate with an external device; and
wherein the processor is further configured to receive updated information relating to diagnostic modes of the vehicle and store the updated information in the database.

5. The system of claim 1, wherein the processor is further configured to:
request data from the electronic control unit of the vehicle and measure a response time for the data from the electronic control unit of the vehicle;
compare the measured response time to an expected response time; and
determine if the measured response time does not match the expected response time.

6. The system of claim 1, wherein the processor is further configured to:
download a stock electronic control unit image from the vehicle;
compare the stock electronic control unit image with an original equipment manufacturer electronic control unit image; and
determine if the stock electronic control unit image does not match the original equipment manufacturer electronic control unit image.

7. The system of claim 6, wherein the stock electronic control unit image has one of a monitor code, a check engine light disable code, or a trouble code.

8. The system of claim 6, wherein the stock electronic control unit image has one of an oxygen sensor disable code, a catalytic converter disable code, a catalytic converter protection codes, a startup delay code, or a diesel particulate filter code.

9. The system of claim 1, wherein the processor is further configured to:
download a flash counter from the electronic control unit of the vehicle;
compare the flash counter to a predetermined value; and
determine if the flash counter exceeds the predetermined value.

10. The system of claim 9, wherein the predetermined value is 20.

11. The system of claim 9, wherein the predetermined value is an expected flash counter provided by a manufacturer of the vehicle.

12. The system of claim 1, wherein the processor is further configured to:
download an intake air temperature from the electronic control unit of the vehicle;
receive from an input device a user provided temperature; and
determine is the intake air temperature matches the user provided temperature.

13. The system of claim 1, wherein the processor is further configured to:
transmit an invalid message to the electronic control unit of the vehicle;
receive an response to the invalid message; and
determine if the response is indicative of a vehicle simulator.

14. The system of claim 1, wherein the processor is further configured to analyze the initialization of the electronic control unit of the vehicle to determine if the electronic control unit of the vehicle has been tampered with or is a vehicle simulator.

15. The system of claim 14, wherein the processor is further configured to analyze background message traffic on a vehicle bus to determine if the electronic control unit of the vehicle has been tampered with or is a vehicle simulator.

16. The system of claim 1, wherein the processor is further configured to:
transmit a bursts of requests;
receive responses to the burst of requests;
measure the response times to the burst of requests; and
determine if the electronic control unit of the vehicle has been tampered with or is a vehicle simulator based on response times.
